(19) United States
(12) Patent Application Publication
(10) Pub. No.: US 2026/0042501 A1
(43) Pub. Date: Feb. 12, 2026

(54) BICYCLE SEATPOST AND MOUNTING ASSEMBLY FOR SADDLE POSITIONING

(71) Applicant: A-PRO TECH CO., LTD, Taichung City (TW)

(72) Inventor: Chih-Ping KUO, Taichung City (TW)

(21) Appl. No.: 19/288,032

(22) Filed: Aug. 1, 2025

Related U.S. Application Data
(60) Provisional application No. 63/679,621, filed on Aug. 6, 2024.

(51) Int. Cl. B62J 1/08

(52) U.S. Cl. CPC B62J 1/08

(57) ABSTRACT

A bicycle seatpost and an associated mounting assembly are disclosed. The seatpost includes a seat tube having a head portion defining two cavities and a linking channel extending therebetween in a radial direction. The head portion further defines two annular walls respectively surrounding and bounding the cavities. The mounting assembly comprises two detent assemblies, two saddle clamps, and a fastening assembly. Each detent assembly is disposed in a respective cavity and engages the corresponding annular wall to restrict rotation. Each saddle clamp clamps a saddle rail of a bicycle saddle and includes a compression member that radially presses the detent assembly, with rotation of the saddle clamp constrained by the detent assembly to fix the pitch orientation of the saddle. The fastening assembly extends through the cavities and linking channel to couple the detent assemblies and saddle clamps, thereby integrating the mounting assembly with the seat tube.

### CROSS-REFERENCE TO RELATED APPLICATIONS

The present application claims priority from U.S. Provisional Patent Application Ser. No. 63/679,621, filed on Aug. 6, 2024.

### FIELD OF THE INVENTION

The present invention relates to positioning mechanisms for bicycle saddles and, more particularly, to a bicycle seatpost and an associated mounting assembly configured to facilitate precise saddle orientation and secure retention.

### BACKGROUND OF THE INVENTION

Bicycles are typically equipped with a saddle that provides a seating surface for a rider. The saddle generally comprises a saddle pad and a pair of saddle rails. The saddle pad defines the surface upon which the rider sits, while each of the saddle rails is configured as an elongated, rod-like structure. The pair of saddle rails is arranged laterally opposite each other beneath the saddle pad. Each of the saddle rails includes a linear middle segment, with opposite ends of the middle segment forming upwardly extending connecting portions that attach to a bottom surface of the saddle pad.

A seatpost is employed to mount and position the saddle relative to a bicycle frame. A conventional seatpost comprises a seat tube, a pair of rail clamps, and a pair of seat tube engaging surfaces. The seat tube is axially inserted into a seat tube socket of the bicycle frame and is vertically slidable therein to adjust a height of the saddle relative to the frame, thereby allowing a rider to select a desired riding position.

The pair of rail clamps is respectively disposed on opposite lateral sides of a terminal end of the seat tube. Each of the rail clamps is configured to securely engage a corresponding one of the saddle rails, thereby preventing translational displacement of the saddle in a fore-and-aft direction relative to the seat tube. Each of the seat tube engaging surfaces is formed integrally with the seat tube and is disposed laterally opposite a corresponding one of the rail clamps. Each of the seat tube engaging surfaces comprises a plurality of seat tube teeth arranged annularly in sequence. Each of the rail clamps further comprises a clamp engaging surface that faces and engages a corresponding one of the seat tube engaging surfaces, the clamp engaging surface comprising a plurality of clamp teeth arranged in an annular sequence.

The pitch angle of the saddle may be adjusted by rotationally displacing the rail clamps about a lateral axis. Upon achieving a desired orientation of the saddle to accommodate a rider's ergonomic needs, a locking bolt is employed to secure the configuration. Tightening the locking bolt urges the seat tube engaging surfaces and the clamp engaging surfaces into lateral abutment, such that each of the clamp teeth engages a corresponding one of the seat tube teeth. This engagement effectively restricts further rotational movement of the saddle.

Although the components of such conventional adjustment mechanisms are generally formed from high-strength rigid materials to ensure positional stability of the saddle, it has been observed that, during extended use, the locking bolt may loosen due to cyclical loading and vibration. This can result in minor angular shifts in the pitch orientation of the saddle. Variations in rider posture and the dynamic application of weight during pedaling exacerbate such deviations, diminishing the ability of the saddle to maintain a fixed pitch orientation. Consequently, the rail clamps may experience reciprocal rotation relative to the seat tube, negatively impacting ride quality and user experience.

These and other objects and advantages of the present invention will become apparent from a reading of the attached specification and appended claims.

### SUMMARY OF THE INVENTION

The primary object of the present invention is to provide an improved bicycle seatpost and an associated mounting assembly for securely positioning a saddle and stabilizing its pitch orientation.

To achieve the aforementioned objective, the present invention provides the following technical solution.

A bicycle seatpost comprising a seat tube configured to be disposed in a frame of a bicycle to position a saddle of the bicycle, the seat tube defining a head portion at one axial end thereof. The head portion includes: two cavities respectively extending to opposite lateral sides of the head portion; a linking channel disposed between and in communication with the two cavities, the linking channel extending along a radial direction; and two annular walls respectively annularly surrounding and bounding the two cavities.

A mounting assembly includes two detent assemblies, two saddle clamps, and a fastening assembly. Each detent assembly is disposed in a corresponding one of the cavities and engages a corresponding one of the annular walls such that the annular wall restricts rotation of the detent assembly relative to the seat tube. Each saddle clamp is configured to clamp a corresponding saddle rail of the saddle, and comprises a compression member extending into a corresponding one of the cavities and pressing a corresponding one of the detent assemblies in a radial direction, each saddle clamp being rotationally constrained by the corresponding detent assembly to fix a pitch orientation of the saddle.

The fastening assembly serially connects the detent assemblies and the saddle clamps through the cavities and the linking channel, thereby integrally coupling the mounting assembly to the seat tube.

Each of the detent assemblies engages a corresponding one of the annular walls in the radial direction, whereby the seat tube constrains rotational displacement of the detent assemblies through the engagement between the detent assemblies and the annular walls. As a result, the saddle is maintained in a stable pitch orientation in space. Variations in the rider's posture during use do not easily disturb the fixed pitch configuration of the saddle, thereby reducing instability and improving rider experience.

### BRIEF DESCRIPTION OF DRAWINGS

FIG. 1 is a perspective view of a first embodiment of the bicycle seatpost according to the present invention,

FIG. 2 is an exploded perspective view of the first embodiment.

FIG. 3 is a perspective view of a detent assembly of the first embodiment.

FIG. 4 is a partially enlarged view of FIG. 3, showing a portion of a detent element.

FIG. 5 is a partial perspective cross-sectional view of the first embodiment.

FIG. 6 is a planar cross-sectional view of the first embodiment.

FIG. 7 is a cross-sectional view taken along line 7-7 of FIG. 6.

FIG. 8 is a cross-sectional view taken along line 8-8 of FIG. 6.

FIG. 9 is a perspective view of a detent assembly of a second embodiment of the present invention.

FIG. 10 is a partial cross-sectional view of the second embodiment.

### DETAILED DESCRIPTION OF THE INVENTION

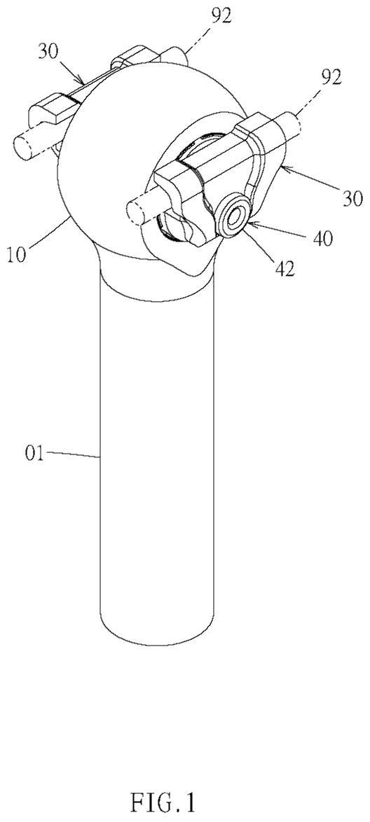

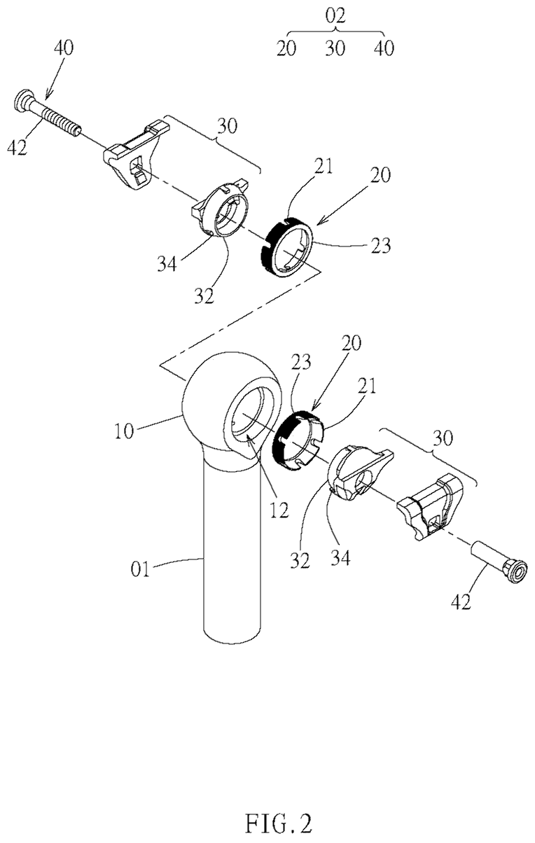

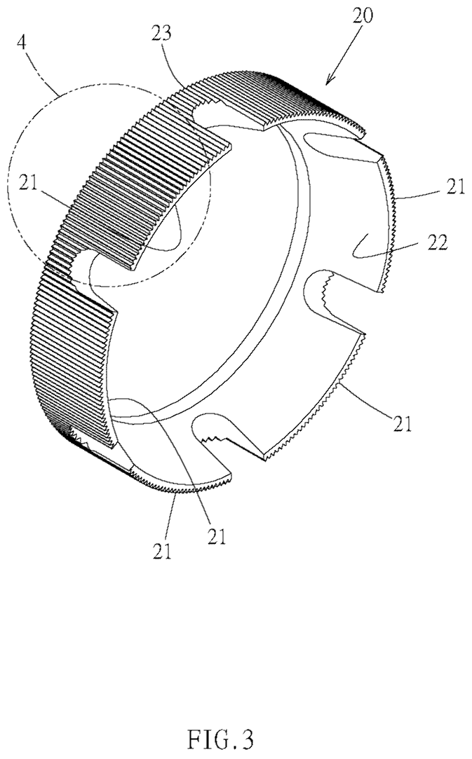

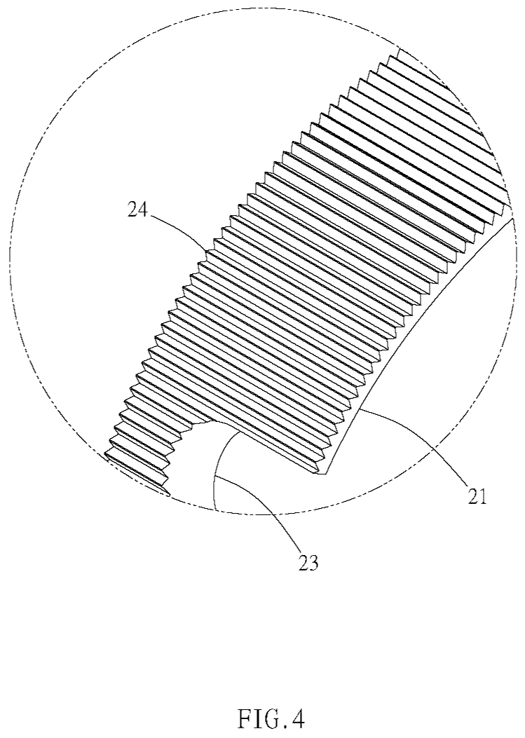

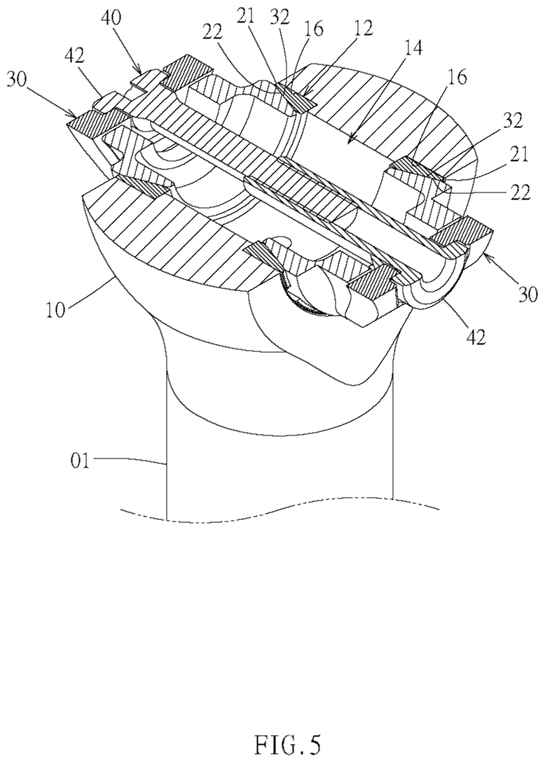

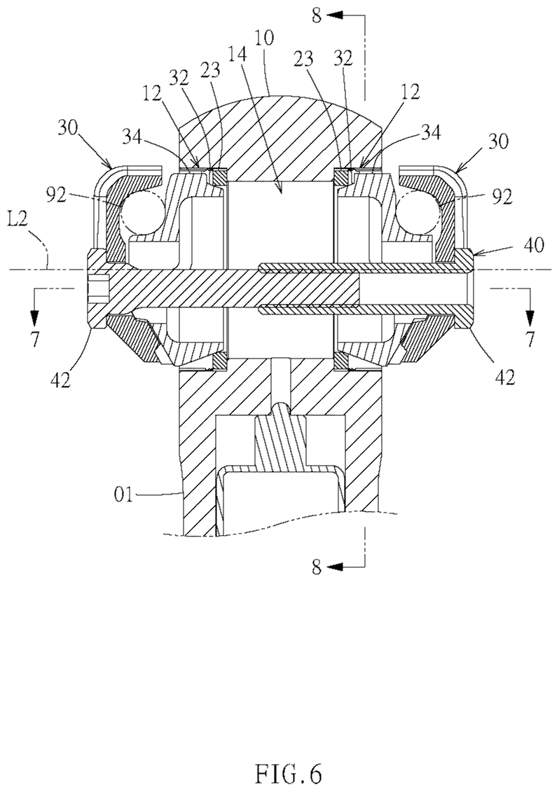

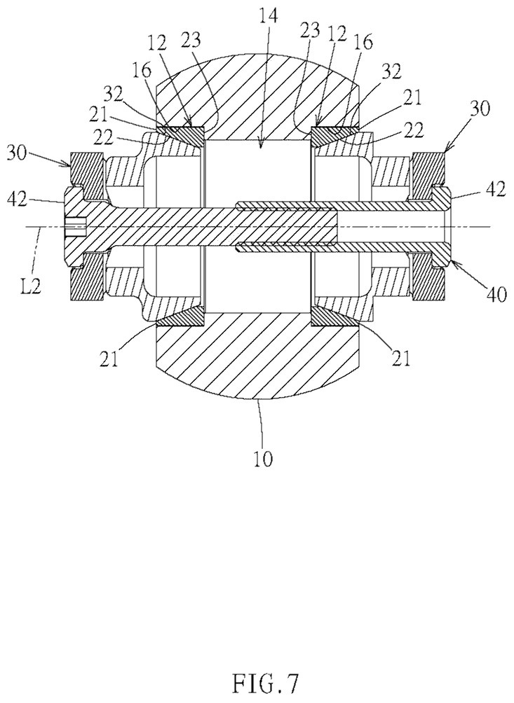

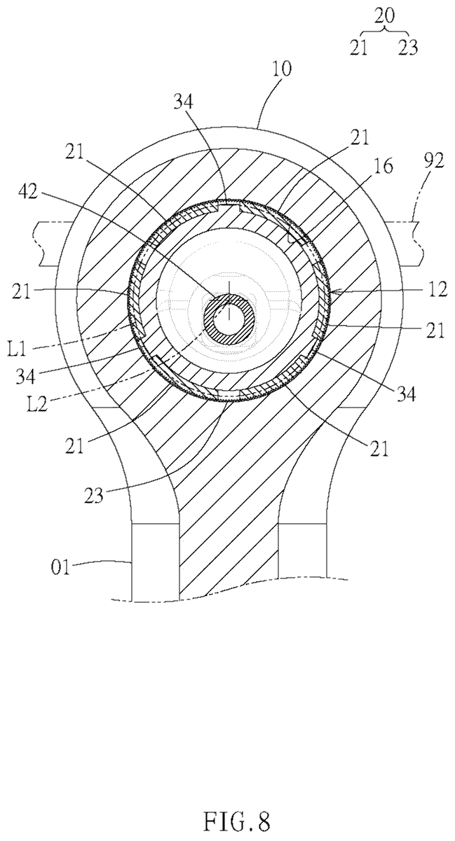

Referring to FIGS. 1 through 8, a first embodiment of the bicycle seatpost of the present invention comprises a seat tube 01 and a mounting assembly 02. The seat tube 01 is configured to be installed in a frame of a bicycle (not shown) to support and position a saddle. The seat tube 01 defines a head portion 10 at one axial end. The head portion 10 includes two cavities 12 and a linking channel 14 extending in a radial direction. Each of the cavities 12 extends laterally to a respective side of the head portion 10. The linking channel 14 is located between and communicates with the cavities 12. The head portion 10 further defines two annular walls 16, each of which annularly surrounds and bounds a respective cavity 12.

The mounting assembly 02 comprises two detent assemblies 20, two saddle clamps 30, and a fastening assembly 40. Each of the detent assemblies 20 is disposed within a respective cavity 12 and is configured to engage a corresponding annular wall 16. Each of the annular walls 16 thereby restricts rotation of the corresponding detent assembly 20 relative to the seat tube 01.

Each of the saddle clamps 30 is configured to clamp a respective saddle rail 92 of the saddle. Each saddle clamp 30 defines a compression member 32 that extends into a corresponding cavity 12 and applies a radial compressive force to a corresponding detent assembly 20. Each saddle clamp 30 is rotationally constrained by the detent assembly 20 it engages, thereby establishing a fixed pitch orientation of the saddle. The specific configuration by which each saddle clamp 30 clamps the corresponding saddle rail 92 may be implemented using conventional mechanisms well known in the art.

The fastening assembly 40 extends through the cavities 12 and the linking channel 14 to serially interconnect the detent assemblies 20 and the saddle clamps 30, thereby integrally coupling the mounting assembly 02 to the seat tube 01.

In a preferred embodiment, the fastening assembly 40 comprises two bolts 42 threadably engaged along a common axis L2. Each of the bolts 42 abuts a corresponding saddle clamp 30 at one of its ends, thereby generating an axial force along the axis L2 that urges each saddle clamp 30 into pressing contact with a corresponding detent assembly 20.

Each saddle clamp 30 securely grips a corresponding saddle rail 92, thereby preventing displacement of the saddle toward or away from a handlebar of the bicycle. Each of the compression members 32 applies a radial force to a corresponding detent assembly 20. In response, each detent assembly 20 engages a respective annular wall 16 in the radial direction. Through this engagement, each annular wall 16 restricts the detent assembly 20 from rotating relative to the seat tube 01, thereby fixing the pitch orientation of the saddle in space. As a result, variations in rider posture during cycling are unlikely to disturb the pitch orientation of the saddle, thereby improving positional stability and enhancing rider experience.

Each detent assembly 20 comprises a plurality of detent elements 21 spaced apart along a virtual circular line L1. The circular line L1 is centered on the axis L2, which extends through a radial center of each cavity 12. Each of the detent elements 21 is configured to contact and engage a corresponding annular wall 16 on an outer side thereof. Each detent element 21 is further configured to receive a compressive force from a corresponding saddle clamp 30 on a side thereof facing the axis L2, such that the detent element 21 tightly abuts the corresponding annular wall 16.

Each of the detent elements 21 exerts a radial outward force against the corresponding annular wall 16. In turn, each annular wall 16 generates a reaction force directed toward the axis L2, thereby restricting rotational movement of the corresponding detent assembly 20 relative to the head portion 10 of the seat tube 01.

Each of the detent elements 21 defines a contact surface 22 on a side facing the axis L2. A distance between the contact surface 22 and the axis L2 decreases progressively along the axis L2, from an end of the corresponding annular wall 16 that is remote from the linking channel 14 toward the linking channel 14.

Each of the contact surfaces 22 forms a portion of a virtual conical surface. In a preferred implementation, each of the detent elements 21 is formed as an arc-shaped, sheet-like structure. The contact surfaces 22 defined by the detent elements 21 are spaced along a circumferential direction about the circular line L1, which surrounds the axis L2, such that the collective geometry of the contact surfaces 22 defines a portion of a virtual cone extending circumferentially along the circular line L1.

Alternatively, each of the detent elements 21 may be configured as a linear (straight) sheet structure, thereby forming another embodiment. In this configuration, a plurality of the straight detent elements 21 is spaced about the axis L2, such that their collective geometry defines a portion of a peripheral surface of a virtual pyramid.

A radially outer periphery of each of the compression members 32 is configured to conform to a corresponding one of the contact surfaces 22, thereby ensuring close surface engagement between the saddle clamps 30 and the detent elements 21.

Each of the saddle clamps 30 further defines a plurality of locking tabs 34. Each of the locking tabs 34 is configured to project into a space between two adjacent detent elements 21 and to abut both of the adjacent detent elements 21 in the circumferential direction along the circular line L1. Through this arrangement, each of the detent assemblies 20 constrains rotation of a corresponding saddle clamp 30, thereby establishing and maintaining a fixed pitch angle of the saddle.

The number of locking tabs 34 provided on each of the saddle clamps 30 may be adjusted according to design requirements. However, each saddle clamp 30 must include at least one locking tab 34 to ensure effective rotational constraint.

In an alternative embodiment, each of the detent assemblies 20 may be formed as an annular structure in place of the spaced detent elements 21. In such embodiments, the inner surface of each annular detent assembly 20 may define a non-circular opening, such as an elliptical hole, a rectangular hole, or another suitable non-circular geometry. Each of the compression members 32 of the saddle clamps 30 is correspondingly configured as an elliptical, rectangular, or otherwise non-circular columnar structure, such that the compression member 32 is inserted into and rotationally constrained within the annular detent assembly 20. In this case, the compression members 32 may omit the locking tabs 34, since the non-circular interfitting geometry alone suffices to restrict relative rotation between the saddle clamps 30 and the detent assemblies 20.

In some embodiments, each of the detent assemblies 20 further comprises an annular connector 23. Each of the annular connectors 23 integrally interconnects the ends of the corresponding detent elements 21 that face the linking channel 14. The inclusion of the annular connectors 23 improves the ease of assembly by allowing the detent elements 21 to be inserted into the cavities 12 as a single unit.

Each of the detent elements 21 may further define a plurality of engagement teeth 24 on an outer surface thereof, arranged sequentially along the circumferential direction of the circular line L1. Each of the engagement teeth 24 is configured to engage the corresponding annular wall 16. The presence of the engagement teeth 24 enhances the effectiveness of circumferential positioning between the detent elements 21 and the annular walls 16.

Each of the engagement teeth 24 may alternatively be replaced with a plurality of pyramid-shaped bosses (not shown). As another alternative, each of the detent elements 21 may define a roughened outer surface to enhance frictional engagement with the corresponding annular wall 16.

Each of the detent elements 21 may optionally be fabricated from an elastic material to accommodate deflection and improve fit and engagement.

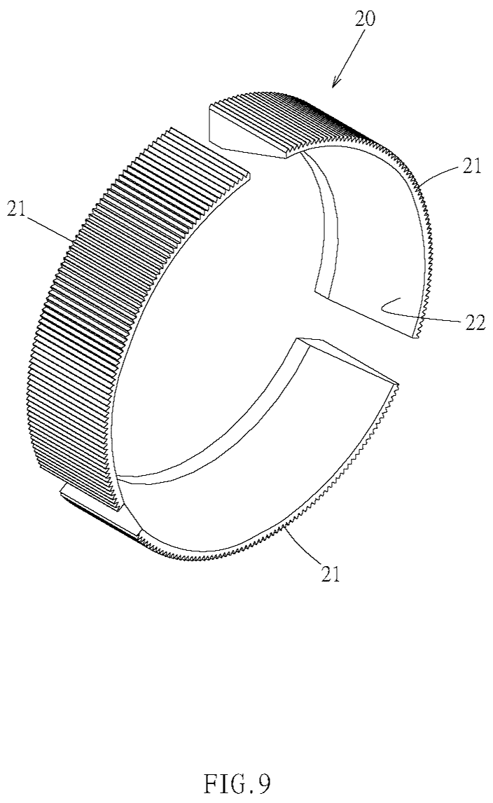

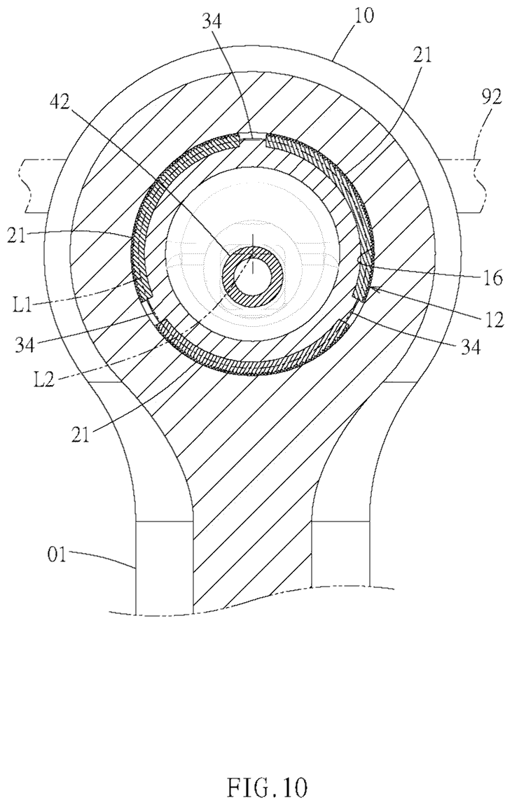

Referring to FIGS. 9 and 10, a second embodiment of the bicycle seatpost is illustrated. The second embodiment differs from the first embodiment primarily in that each of the detent assemblies 20 of the second embodiment does not include the annular connector 23.

1. A bicycle seatpost comprising:
a seat tube configured to be disposed in a frame of a bicycle to position a saddle of the bicycle, the seat tube defining a head portion at one axial end thereof, the head portion comprising:
two cavities respectively extending to opposite lateral sides of the head portion;
a linking channel disposed between and in communication with the two cavities, the linking channel extending along a radial direction; and
two annular walls respectively annularly surrounding and bounding the two cavities;
a mounting assembly comprising two detent assemblies, two saddle clamps, and a fastening assembly, wherein:
each detent assembly is disposed in a corresponding one of the cavities and engages a corresponding one of the annular walls such that the annular wall restricts rotation of the detent assembly relative to the seat tube;
each saddle clamp is configured to clamp a corresponding saddle rail of the saddle, and comprises a compression member extending into a corresponding one of the cavities and pressing a corresponding one of the detent assemblies in a radial direction, each saddle clamp being rotationally constrained by the corresponding detent assembly to fix a pitch orientation of the saddle; and
the fastening assembly serially connects the detent assemblies and the saddle clamps through the cavities and the linking channel, thereby integrally coupling the mounting assembly to the seat tube.

2. The bicycle seatpost of claim 1, wherein each of the detent assemblies comprises a plurality of detent elements spaced along a virtual circular line centered on a virtual axis extending through a radial center of the corresponding cavity, each of the detent elements contacting and engaging a corresponding one of the annular walls on an outer side thereof, and each of the detent elements receiving pressure from a corresponding saddle clamp on a side facing the virtual axis, thereby tightly engaging the corresponding annular wall.

3. The bicycle seatpost of claim 2, wherein each of the detent elements defines a contact surface on a side facing the virtual axis, a distance between each contact surface and the virtual axis decreasing along the virtual axis from an end of the annular wall distal to the linking channel toward the linking channel.

4. The bicycle seatpost of claim 3, wherein each of the contact surfaces constitutes a portion of a conical surface.

5. The bicycle seatpost of claim 3, wherein a radial outer periphery of each of the compression members conforms to a corresponding one of the contact surfaces.

6. The bicycle seatpost of claim 2, wherein each of the saddle clamps comprises at least one locking tab extending between two adjacent detent elements and abutting the detent elements in a circumferential direction along the circular line, such that the corresponding detent assembly restricts rotation of the saddle clamp in contact therewith and thereby fixes the pitch orientation of the saddle.

7. The bicycle seatpost of claim 2, wherein each of the detent assemblies further comprises an annular connector interconnecting ends of the detent elements facing the linking channel.

8. The bicycle seatpost of claim 2, wherein each of the detent elements defines a plurality of engagement teeth on an outer surface thereof, arranged sequentially along the circumferential direction of the circular line, each of the engagement teeth engaging a corresponding annular wall.

9. A mounting assembly for use in a bicycle seatpost for positioning a saddle of a bicycle, the bicycle seatpost comprising a seat tube configured to be disposed in a frame of the bicycle, the seat tube defining a head portion at one axial end thereof, the head portion comprising:
two cavities respectively extending to opposite lateral sides of the head portion;
a linking channel disposed between and in communication with the cavities and extending along a radial direction; and
two annular walls respectively annularly surrounding and bounding the cavities;
the mounting assembly comprising:
two detent assemblies respectively configured to engage the annular walls to restrict rotation of the detent assemblies;
two saddle clamps respectively configured to clamp saddle rails of the saddle, each of the saddle clamps comprising a compression member configured to enter a corresponding one of the cavities and apply a radial pressing force to a corresponding one of the detent assemblies, and each of the saddle clamps being restricted from rotation by the corresponding detent assembly to fix a pitch orientation of the saddle; and
a fastening assembly configured to serially connect the detent assemblies and the saddle clamps.

10. The mounting assembly of claim 9, wherein each of the detent assemblies comprises a plurality of detent elements spaced along a virtual circular line centered on a virtual axis, each of the detent elements receiving pressure from a corresponding saddle clamp on a side facing the virtual axis and tightly engaging a corresponding annular wall.

11. The mounting assembly of claim 10, wherein each of the detent elements defines a contact surface on a side facing the virtual axis, a distance between each contact surface and the virtual axis decreasing along the axis from one end of the detent element toward an opposite end.

12. The mounting assembly of claim 11, wherein each of the contact surfaces constitutes a portion of a conical surface.

13. The mounting assembly of claim 11, wherein a radial outer periphery of each of the compression members conforms to a corresponding one of the contact surfaces.

14. The mounting assembly of claim 10, wherein each of the saddle clamps comprises at least one locking tab extending between two adjacent detent elements and abutting the detent elements in a circumferential direction of the circular line, such that the detent assembly restricts rotation of the saddle clamp.

15. The mounting assembly of claim 10, wherein each of the detent assemblies further comprises an annular connector interconnecting ends of the detent elements.

16. The mounting assembly of claim 10, wherein each of the detent elements defines a plurality of engagement teeth on an outer surface thereof, arranged sequentially along the circumferential direction of the circular line, each of the engagement teeth engaging a corresponding annular wall.
